(19) United States
(12) Patent Application Publication
(10) Pub. No.: US 2005/0204631 A1
(43) Pub. Date: Sep. 22, 2005

(54) System and methods for arc shutters

(76) Inventor: Carlos Marques Cabrera, San Diego, CA (US)

Correspondence Address: Law Office of Eric B. Alspaugh, P.O Box 8671, SAN DIEGO, CA, 92138, US

(21) Appl. No.: 10/806,768

(22) Filed: Mar. 19, 2004

(51) Int. Cl. E06B 7/08

(52) U.S. Cl. 49/86.1; 49/74.1

(57) ABSTRACT

A system and method for synchronizing the louvers of an arched window shutter assembly having rotatable louvers radially mounted to a base member and an arched member for shuttering curved windows.

### BACKGROUND OF THE INVENTION

I. Field of the Invention

This invention relates to the field of window shutters, in particular to a system and method for synchronizing the louvers of an arched window shutter assembly having rotatable louvers, radially mounted to a base member and an arched member for shuttering curved windows.

II. Discussion of the Prior Art

Arc shutters are used to decorate window spaces and regulate the amount of ambient light. Such regulation of ambient light can serve several useful functions such as allowing daylight in during the day to reduce the amount of energy expenses associated with typical light bulb lighting systems. The background art discloses several methods of attempting to increase arched shutter performance, for instance in U.S. Pat. No. 6,536,162 issued to LaMay and U.S. Pat. No. 5,713,156 issued to Briggs, Sr. disclose systems implementing gears in order to achieve machine precision. These articles disclose theoretically possible yet practically difficult to implement. The background art requires machined parts of highly reproducible quality. U.S. Pat. No. 5,417,789 issued to Faircloth disclosed a simple solution of attaching a bar to the louvers via loose staples, while this was able to move the louvers there was too much play and the louvers would not line up precisely, thus loosing the aesthetic value. In addition, Faircloth required a bar to be hung in the middle of the shutter thus obstructing views and further reducing overall aesthetics. Yet another approach to harmonizing louver opening came in the form of magnetized louvers in U.S. Pat. No. 6,918,417 issued to Kinder. In that case, the louvers theoretically achieved the goal of synchronization and was aesthetically pleasing, the draw back came from manufacturing with precision and consistency. Magnets operating through attraction and repulsion require very smooth attachment points. Even the slightest deviation in construction rendered those louvers in-operable.

Window shutters are used to shield a room or area from the elements and help provide privacy. In addition, window shutters preferably also add to the aesthetic appeal of the décor.

The louvers, which are typically disposed through a range from a fully horizontal position to a vertical position and again over to a fully horizontal position, and are movable rotatably between a closed position wherein it serves as a barrier to the elements, to an open position wherein light may shine through. Positioning the louvers at any point between the fully closed position and the fully open position allows regulation of ambient light as well as provide for a manner of directing light.

In order to adjust a plurality of louvers simultaneously, an adjustment arm or member is attached to the louvers, which essentially chains them together so that moving any one of the louvers to any position causes a corresponding movement of the remaining louvers that are correspondingly attached by the adjustment arm or member. There are some designs that place the adjustment arm or member on the side edge of the louver so as to prevent obstruction of the view therethrough when the louvers are open, however, these adjustment arms or members, regardless of whether they are disposed in the center or side edge of the louvers, generally detract aesthetically from the overall appearance of the window shutter.

To solve the problems of obstruction and aesthetics caused by the adjustment arm or member, internal mechanisms were incorporated within the window shutter to allow for synchronized adjustment of the louvers. These internal adjustment mechanisms proved to be complicated, requiring an excessive number of components and thus are very expensive to manufacture.

Accordingly, there is a need for an adjustable window shutter having a louver adjustment that is relatively inconspicuous, yet simple in design and inexpensive to manufacture. The present invention satisfies these needs, as well as others, and generally overcomes the deficiencies found in the background art.

### SUMMARY OF THE INVENTION

The present invention provides a system and method for opening and closing arc shutters in a synchronized manner.

One object of the invention is to provide an adjustable window shutter apparatus having a louver adjustment member that is relatively inconspicuous.

Another object of the invention is to provide and adjustable window shutter apparatus that is simple and does not require expensive machined assemblies.

Still another object of the invention is to provide and adjustable window shutter apparatus that is reliable in use and resistant to distortion.

Still another object of the invention is to provide and adjustable window shutter apparatus that is capable of assembly on prefabricated shutters or shutters that are currently installed.

Further objects and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

It is convenient to hereinafter describe embodiments of the present invention with reference to the accompanying drawings. It is to be appreciated that the particularity of the drawings and the related description is to be understood as not superseding the broad description of the invention in which:

FIG. 1 is a back view of the invention 100;

FIG. 2 is an enlarged view of the wheel crank 10, illustrating (among other things) the attachment of the tension cable 14 to the tension cable wheel mount 44 of the wheel crank 10;

FIG. 3 is an enlarged view of the arched member 6 with the eyelet connector 12 directing the flow of the tension cable 14 to the distal synchronization bar mount 46;

FIG. 4 is an enlarged view of arched member 6 and louver 8 illustrating the top louver connector 16;

FIG. 5A is an exploded view of the distal pin receiver 32 and the pin 30 illustrating (among other things) how the pin 30 would fit into the distal pin receiver 32;

FIG. 5B is a sectional view of the distal pin receiver hole 28 and the pre-drilled hole in the arched member 48 illustrating how the distal pin receiver 30 and pin 32 would fit into the louver 8 and arched member 6, respectively;

FIG. 6 is an enlarged view of the base connector member 4 illustrating (among other things) the connection of louver 8 to the base connector member 4 via mounting shaft 22;

FIG. 7A is a sectional view of the base connector member pin receiver hole 34 and the proximal pin receiver hole 40;

FIG. 7B is an exploded view of base connector member pin receiver, pin 32, and spring 36;

FIG. 8 is a side view of the invention 100, illustrating (among other things) the arched member 6 with a partial sectional view of the base member 2 exposing the connection of the wheel crank 10, handle shaft 26 and handle 24;

FIG. 9 is a front view of the invention 100 illustrating (among other things) the louvers 8 in a closed position; and

FIG. 10 is a front view of the invention 100 illustrating (among other things) the louvers 8 in the open position.

### DETAILED DESCRIPTION OF THE DRAWINGS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. The methods for actuating an arched louver system disclosed herein boast a variety of inventive features and components that warrant patent protection, both individually and in combination.

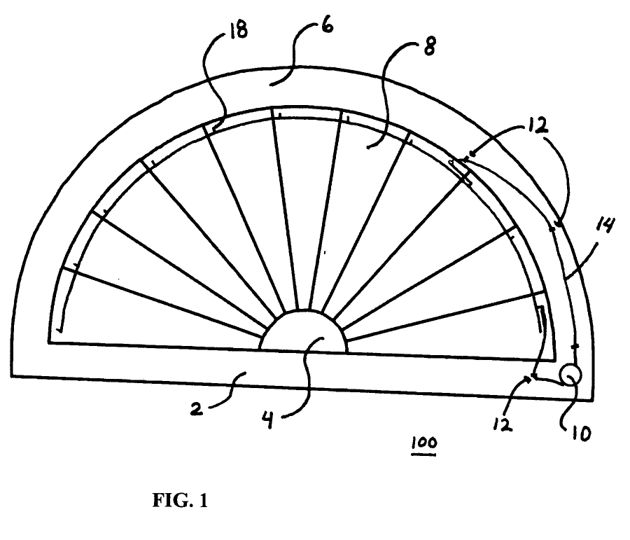

FIG. 1 is a view of the back of the invention 100, illustrating (among other things) the louvers 8 in the closed position. Further, the method of attachment of the louver 8 is via a rotatable connector 18 which allows the free movement of the synchronization bar 20 from side to side thus actuating all the louvers 8 in synchrony. It should further be noted that the rotatable connector 18 allows the synchronization bar 20 to rotate freely and is positioned on the louver 8 such that the synchronization bar has clearance to avoid interference between adjacent louvers 8 and arched member 6. In the current embodiment of the invention 100, the method of attaching the louver 8 to the proximal synchronization bar mount 50 via the tension cable 14 is then directed to the crank wheel 10 through connector eyelet 12. The tension cable 14 is further connected to the distal synchronization bar mount 46 being directed through a plurality of connector eyelets 12. It would be obvious to one skilled in the art that the louvers 8 and synchronization bar could be made of many different suitable materials including wood, metal, or polymer.

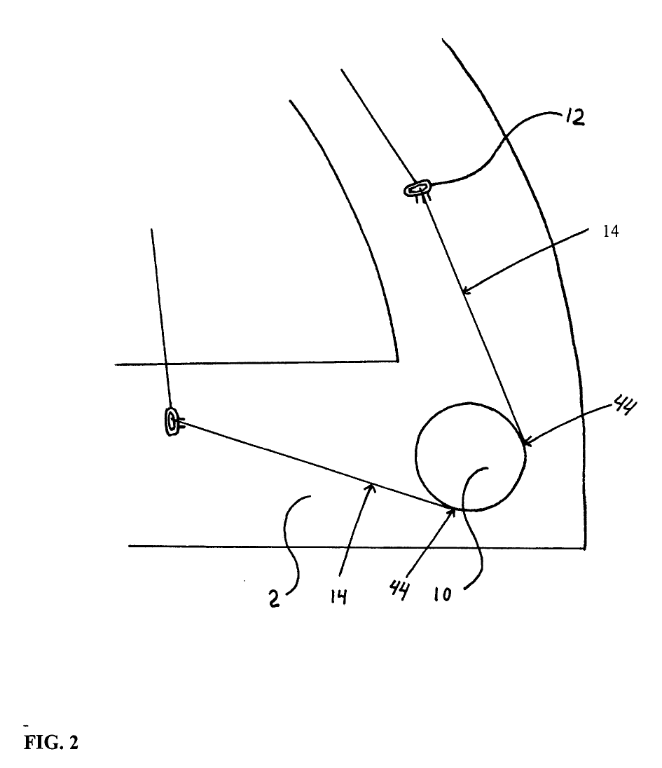

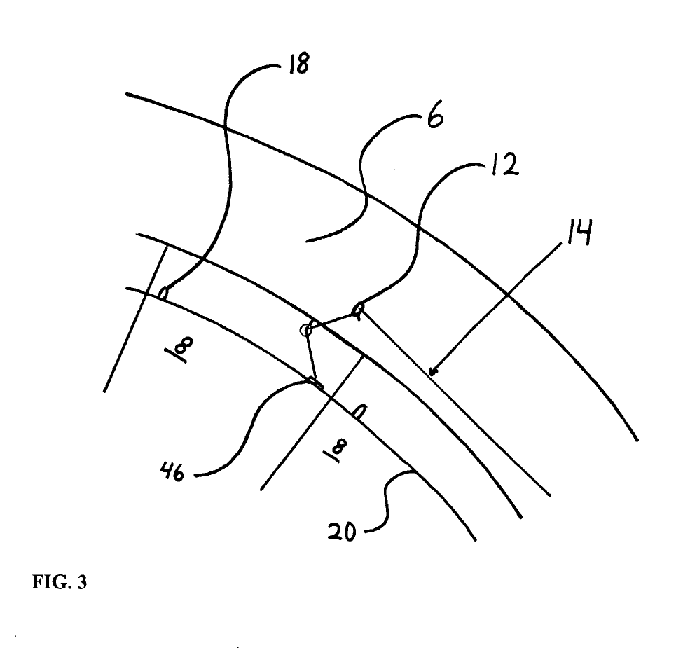

FIGS. 2-3 illustrate (among other things) a detailed method of attachment of the tension cable to two different louvers 8. When the wheel crank 10 is rotated in the counter clock-wise direction the louvers open via the tension applied in the tension cable 14 at the distal synchronization bar mount 46. When the wheel crank 10 is rotated in the clock-wise direction the louvers 8 are closed via the tension applied to the proximal synchronization bar mount 50. It should be appreciated by one skilled in the art that method of attachment of the tension cable 14 to the wheel crank 10 is at about opposite sides of the wheel crank 10 at the tension wheel crank mounts 44. It is not necessary that the tension wheel crank mounts 44 placed exactly opposite each other on the wheel crank 10 thus facilitating the easy of installation at the site of manufacture or as a retrofit in situs. Further in another embodiment it can be appreciated by one skilled in the art that the method of attachment of the tension cable 14 to the synchronization bar 20 can be routed along the base member 2 with connector eyelets 12 and that the synchronization bar 20 can be attached to the louvers 8 at the proximal end, near the base connector member 4 (not shown). Additionally, it can be appreciated by one skilled in the art that the tension cable 14 could be manufactured out of many suitable materials including metal, string, nylon or other various polymers. Likewise, one skilled in the art could appreciate that the wheel crank 10 disclosed could be made of many suitable materials including wood, metal or polymer. Further it can be appreciated that the wheel crank 10 could have a grooved circumference to accept the tension cable 14 in a directed manner.

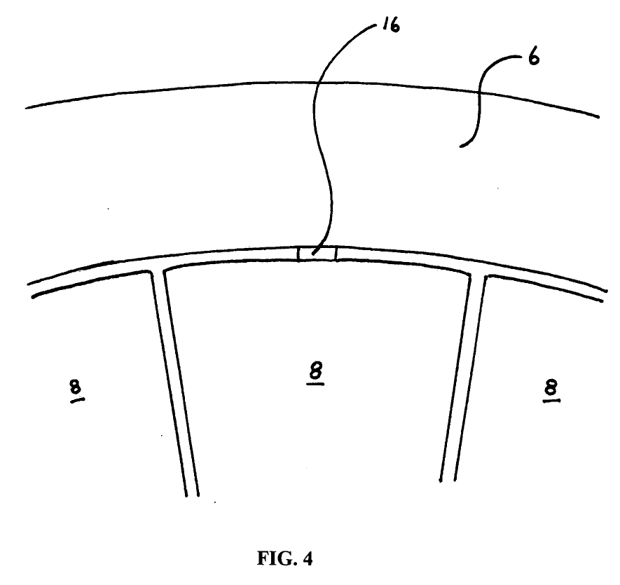

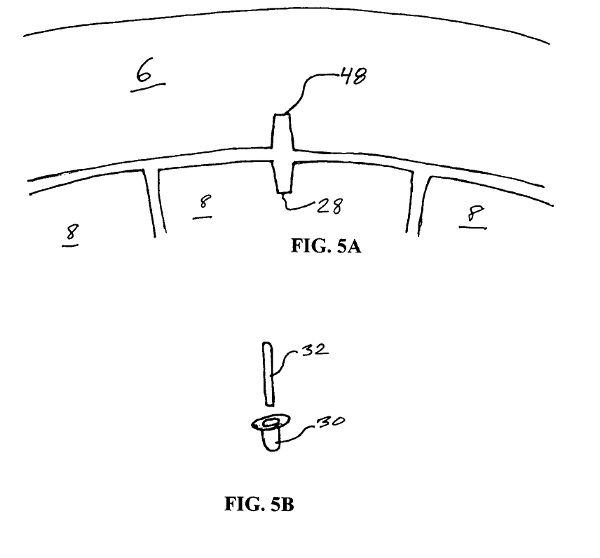

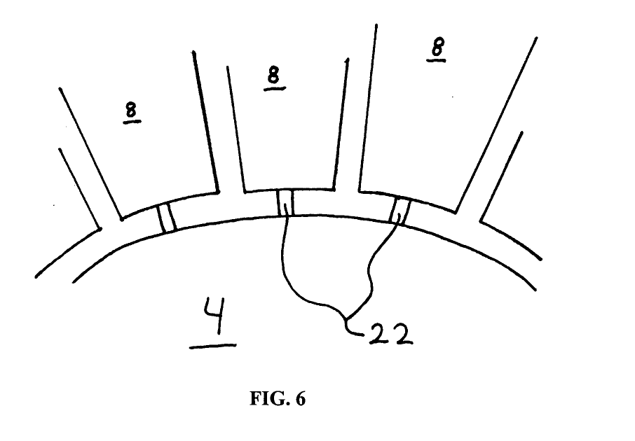

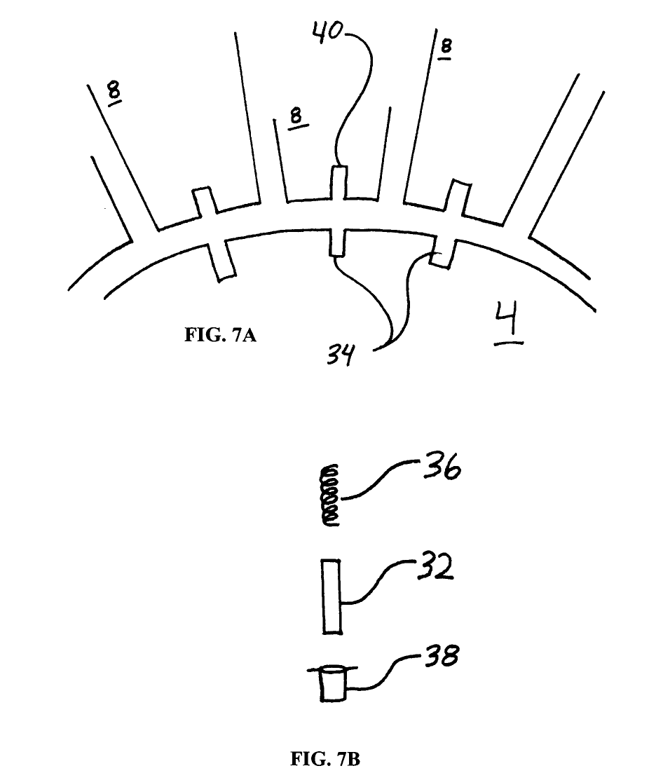

FIGS. 4-7 illustrate one embodiment of the invention 100, method of attachment of the louvers 8 to the base connector member 4 and the arched member 6. FIG. 4 discloses a pin 32 that is disposed between the arched member 6 and a louver 8. The distal pin receiver 30 is disposed of in the distal pin receiver hole 28 of the louver 8. A pin 32 may be inserted into the distal pin receiver 30 and also into the pre-drilled hole into in the arched member 48. Thus, the pin 32 acts as a method of attachment of the louver 8 to the arched member 6. The method of attachment of the louver 8 to the arched member 6 is by way of example, and while one method is disclosed it is clear that one skilled in the art would contemplate several equivalent methods such as the use of metal, wood or polymer variants.

The louver 8 is attached at the proximal end to the base connector member 4 by a mounting shaft 22. More specifically, the base connector member 4 has a plurality of base connector member shaft receiver holes 34 in which are disposed a base connector member shaft receiver 38. The connector member shaft receiver 38 is capable of receiving a mounting shaft 22. The mounting shaft 22 is held in place between the base connector member 4 and the louver 8 by a spring 36 which is disposed of in the louver 8 in the proximal shaft receiver hole 40. This method of attachment provides for a low friction environment for the louver 8 to be rotated. Additionally, it can be appreciated that such a system could be retrofitted to an existing arc.

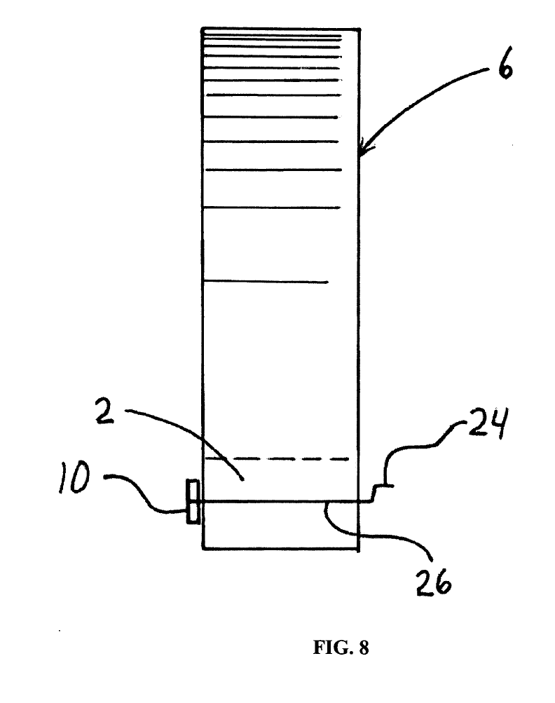

FIG. 8 illustrates (among other things) the side view of the invention 100 further showing that the wheel crank 10 attached to a handle 24 via a handle shaft 26. It would be appreciated by one skilled in the art that the handle shaft 26 will traverse the base member 2. The embodiment discloses a simple handle 24 for actuating the wheel crank 10; however, it would be readily obvious to one skilled in the art that many commercially available handle actuating mechanisms are available for operating vertical and horizontal blinds and that they would be used in a similar fashion on the disclosed invention 100.

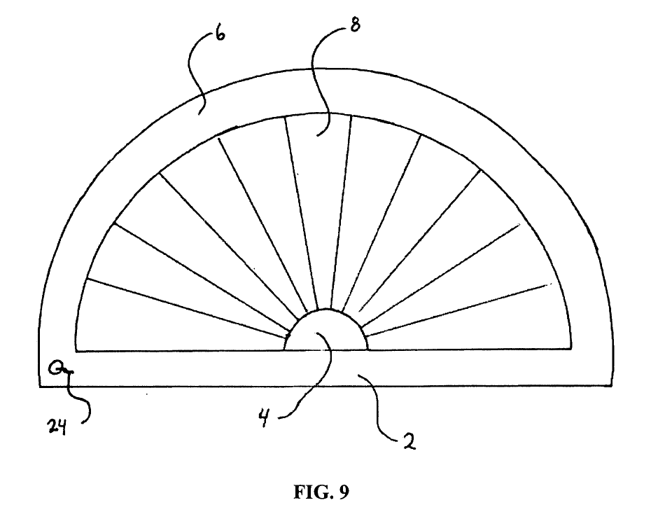

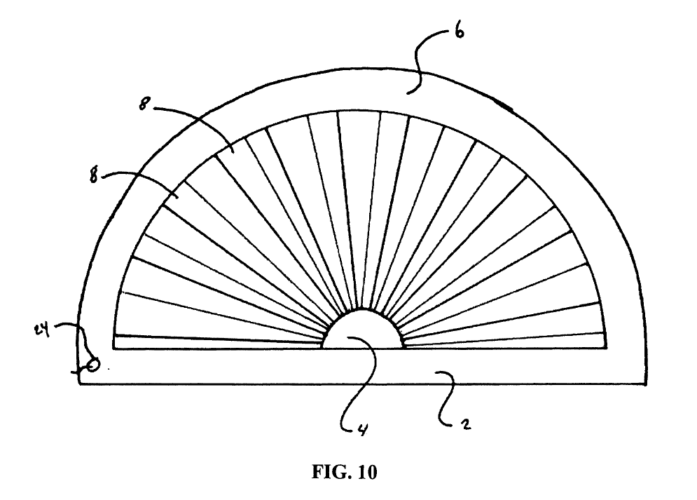

FIGS. 9-10 illustrate the front view of the invention 100, with the louvers 8 in the open and closed position. In the present embodiment it should be appreciated that the louvers 8 can be stably positioned in any position between fully closed and the opened position of 90 degrees perpendicular to the closed plane and further to an open position approximately to the closed position at 180 degrees of rotation.

1. A system and method for an arc shutter comprising:
a plurality of eyelet connectors directing a tension cable to a synchronization bar that is further attached to a wheel crank capable of opening and closing louvers of an arc shutter.

2. The system and method of claim 1, wherein said wheel crank is housed in a base member.

3. The system and method of claim 1, wherein said wheel crank is actuated by a handle.

4. A system and method for an arc shutter comprising:
A tension cable and a plurality of louvers wherein said tension cable is threaded through a plurality of eyelet connectors along the perimeter of a base member and an arched member to attach to a connector bar, said connector bar having a plurality of rotatable connectors attached to each of said plurality of louvers and said plurality of louvers are capable of synchronous opening when said tension cable is wound around a wheel crank in the counter-clockwise direction and conversely, capable of closing when said tension cable is wound around said wheel crank in the clockwise direction.

5. A system and method for an arc shutter, comprising:
an arched member, a base member, and a plurality of louvers attached to a base connector member and the arched member,
said louvers being attached to the arched member with a pin and to said base connector member with a pin,
said louvers are connected to each other through a synchronizing bar, said synchronizing bar is actuated with a tension cable that attaches to said synchronizing bar at two locations and said tension cable is threaded through a plurality of connector eyelets which is further attached to a wheel crank,
said wheel crank when turned rotates said lovers in unison to open and close the arc shutter.

6. A system and method for an arc shutter, comprising:
an arched member having a top and bottom sides, a base member having a base connector member fixed generally in a central location, said base connector member capable of receiving a plurality of louvers, said louvers further capable of freely rotatable attachment to said bottom side of said arched member; and
a synchronizing bar which is fixed to each louver by a rotatable connector which allows the louvers to rotate in synchrony; and
a wheel crank that is attached to said synchronizing bar at two locations, via a tension cable and;
whereby clockwise rotation of said wheel crank will cause the louvers to close and conversely, counter-clockwise rotation of said wheel crank will cause the louvers to open.
